(19) United States
(12) Patent Application Publication
(10) Pub. No.: US 2016/0259921 A1
(43) Pub. Date: Sep. 8, 2016

(54) METHOD FOR PACKAGING CONTENT RIGHTS

(71) Applicant: Unitend Technologies Inc., Beijing (CN)

(72) Inventors: Xinjun WANG, Beijing (CN); Zhijian LIANG, Beijing (CN); Hongbing MEI, Beijing (CN)

(21) Appl. No.: 14/639,656

(22) Filed: Mar. 5, 2015

(51) Int. Cl. G06F 21/10; G06F 21/60

(52) U.S. Cl. CPC G06F 21/105; G06F 21/604; G06F 2221/0768

(57) ABSTRACT

The present invention provides a method for packaging content rights, wherein the relationship of a content, an object and a right are described and bound by using a data structure with an tag so as to describe the content rights. By adopting the method for packaging content rights provided by the present invention, the interoperability is strong, meanwhile, the content rights can be defined flexibly, thereby ensuring that the method has good expansibility; in addition, the content rights are described by a binary system to improve the storage efficiency of the content rights and reduce the occupied system resources, thus ensuring that the method is suitable for hardware processing, and the method is a simple, convenient, efficient, flexible and extensible method for describing the content rights.

### FIELD OF THE INVENTION

The present invention relates to the field of digital rights management, and particularly relates to a method for packaging content rights.

### BACKGROUND OF THE INVENTION

A digital rights management system is mainly used for issuing content rights from authorization systems to terminals, and the interoperability between the authorization systems and the terminals of different standards and versions is a problem needing to be solved in the digital rights management system.

In order to improve the interoperability of the systems and the terminals, the digital rights management system appoints a permission set given to a user (and an intermediate entity, such as a publisher or library) and conditions and obligations of exercising these permissions by using a digital right expression language (Digital Right Expression Language, DREL). That is to say, the digital right expression language accurately defines and describes who owns what authority of what digital information products and which authorities are granted to who within what scope in accordance with what protocol and transaction manner. At present, DREL mainly includes XrML (Extensible Rights Markup Language, extensible rights markup language), ODRL (Open Digital Right Language, open digital right language) and MPEG-21 REL (the fifth part of the MPEG-21).

ODRL and MPEG-21 REL are modeled on the real world rights management, their syntaxes are based on XML. The difference lies in that ODRL is closer to practical affairs in the real world and is easier to understand, but MPEG-21 REL is intended to have a wider application. ODRL is simpler, directly expressed, easy to understand and easy to implement. XrML2.0 is very complex and huge, although XrML2.0 is simplified by MPEG-21 REL, due to the inheritance of XrML core and the standard extension, XrML2.0 still feels large, complete and complex, it contains some mechanisms, such as mode and variable, although being highly flexible and concise when providing description authority, the expression of the two mechanisms is difficult to understand and is not conducive to the subsequent authorization verification. From the perspective of stability, as a large and complete international standard, MPEG-21 REL has high stability and will not change within a short time. From the perspective of an ODRL2.0 model, there is a larger change in comparison with ODRL1.1, although claimed downward compatibility, but due to the deletion of some elements, there are some difficulties in compatibility.

Because the main digital right expression language uses XML language description, the right expression efficiency is poor, the expression is complex to be unbeneficial for the subsequent authorization verification; as far as version compatibility is considered, downward compatibility is difficult to achieve.

### SUMMARY OF THE INVENTION

The present invention provides a method for packaging content rights, which can be used for effectively improving the transmission efficiency of content rights and is simpler in expression, easy to achieve subsequent authorization verification, good in extensibility and easy to achieve downward compatibility.

Firstly, the present invention provides a method for packaging content rights, including the following steps: describing and binding the relationship of a content, an object and a right by using a data structure with an tag; obtaining a corresponding right logical operator; calculating the content, the object and the right according to the obtained right logical operator by using a calculator to generate a right formula; describing the content rights according to the operational result of the right formula.

According to one aspect of the present invention, the content is an electronic thing, such as a graph, a text, audio, video, animation and a set thereof (e.g., a file, a database, software, an executable code, etc.), and all digital things are the content. The object is a carrier of related rights of appointed contents, for example, people, equipment, region, time, family and the like, wherein the equipment can be a general term of software, hardware and a set thereof, which are distinguished from other things, for example, a computer, a computer cluster, a home network, a domain, a cell network, a server, a television, a mobile phone, a tablet computer, a display, a CPU, a memory (a hard disk, FLASH, RAM, etc.), an operating system, a browser, player software and other software, hardware and a set thereof. The right is the authority of using the content, for example, count, duration, time, range, manner, etc. The content rights are described by describing and binding the relationship of the content, the right and the object.

Secondly, the present invention provides a simple, convenient, efficient, flexible and extensible method for describing a content, an object and a right, namely, describing the content, the right and the object by using a data structure with an tag. The content, the object and the right are identified to be collectively defined, which is not only convenient to analyze the three elements, but also is convenient for subsequent extension.

In addition, the present invention provides a simple, convenient, efficient, flexible and extensible method for describing and binding a content, an object and a right, namely, by calculating the right, establishing a right formula and calculating right relationship to obtain content rights so as to describe the content manner; on the basis of describing the content, the right and the object by using a uniform tag, the right formula is described by using a data structure with a tag to further simplify the description of content rights and facilitate the operation of the content rights. The right operation includes all applicable operations, for example, such logic operations as AND, OR, NOT, XOR and the like, and is called a calculator collectively. AND expresses owning a right under two rights at the same time; OR expresses owning two rights at the same time; NOT expresses prohibiting owning the right. The content right description can also be used for describing the right operation between two content right descriptions, in order to further simplify the right description and improve the authorization efficiency.

According to one aspect of the present invention, the right logical operator describes the index numbers of descriptors participating in the operation, the index numbers are sequentially numbered according to the position sequences of the descriptors in a content right descriptor and are numbered from 0, and the logical operator is numbered as well and can also be quoted by the subsequent logical operator so as to achieve iterative operation. As for the right logical operators for describing a right operation method, there may be none, and if there is none, the content, the object and the right all form AND relationship.

To sum up, the method for packaging content rights provided by the present invention is very simple to express and implement and is strong in interoperability; meanwhile, the content rights can be defined flexibly, thereby ensuring that the method has good extensibility; in addition, the content rights are described by a binary system to improve the storage efficiency of the content rights and reduce the occupied system resources, thus ensuring that the method is suitable for hardware processing; furthermore, the method can be used for conveniently grouping the object, the content and the right to improve the authorization efficiency.

### BRIEF DESCRIPTION OF THE DRAWINGS

FIG. 1 is a schematic diagram of a content right description provided by an embodiment of the present invention.

FIG. 2 is a content right description provided by a first embodiment of the present invention.

FIG. 3 is a content right description provided by an example 1 in a second embodiment of the present invention.

FIG. 4 is a content right description provided by an example 2 in a second embodiment of the present invention.

FIG. 5 is a content right description provided by an example 1 in a third embodiment of the present invention.

FIG. 6 is a content right description provided by an example 2 in a third embodiment of the present invention.

FIG. 7 is a content right description provided by an example 1 in a fourth embodiment of the present invention.

### DETAILED DESCRIPTION OF THE EMBODIMENTS

In order that the purposes, technical solutions and advantages of the present invention are clearer, a further detailed description of the present invention will be given below in combination with accompanying drawings and specific embodiments.

A TLV format is an efficient data structure with a tag, a TLV format descriptor is used for describing content rights in this embodiment, and the relationship of a content, an object and a right is described by a calculator to describe the content rights.

### Embodiment 1

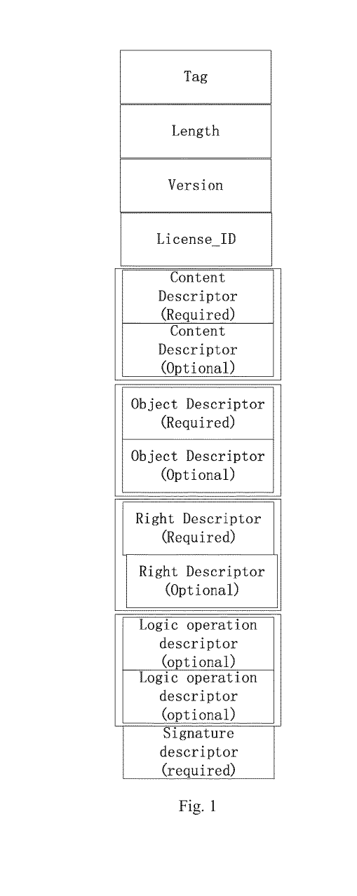

The content right description is described as follows by using TLV descriptors, the tags of the descriptors are uniformly numbered and cannot be duplicated, and as shown in FIG. 1, they are defined as follows:

| | Bit | | |
|---|---|---|---|
| Field | number | Type | Description |
| License { | | | |
| Tag | 8 | Uimsbf | 0x0001 |
| Length | 32 | Uimsbf | Length of the data |
| | | | structure |
| Version | 8 | Uimsbf | Version |
| License_ID | 64 | Uimsbf | License ID |
| Content_Descriptor_Length | 32 | | Content descriptor length |
| For(i = 0; i < m, i++){ | | | |
| Content_ Descriptor( ) | | | Content descriptor |
| } | | | |
| Object_Descriptor_Length | 32 | | Object descriptor length |
| For(i = 0, i < m, i++){ | | | |
| Object_Descriptor ( ) | | | Object descriptor |
| } | | | |
| Rights_Descriptor_Length | 32 | Uimsbf | Right descriptor length |
| For(i = 0; i < m, i++){ | | | |
| Rights_Descriptor ( ) | | | Right descriptor |
| } | | | |
| Operation_Descriptor_Length | 32 | | Calculator descriptor |
| | | | length |
| For(i = 0; i < m, i++){ | | | |
| Operation_Descriptor( ) | | | Calculator descriptor |
| } | | | |
| Signature_Descriptor( ) | | | Signature descriptor |
| } | | | |

The content right description is composed of a tag, a length, a version, a serial number, a content descriptor (Content_Descriptor), an object descriptor (Object_Descriptor), a right descriptor (Rights_Descriptor), a calculator descriptor (Operation_Descriptor) and a signature descriptor (Signature_Descriptor):

(1) the tag is used for describing the data structure as the content right description.
(2) The length is used for describing the length of the data structure.
(3) The version number is the version of the data structure.
(4) The license ID is the unique serial number of the content right description.
(5) The content descriptor is used for describing the condition of the content, including encryption algorithm, key and the like, and there must be at least one and may be multiple.

### Content Descriptor

| | Bit | | |
|---|---|---|---|
| Field | number | Type | Description |
| Content_Descriptor{ | | | |
| Tag | 16 | Uimsbf | 0x1001 |
| Length | 16 | Uimsbf | |
| Content_ID | 64 | Uimsbf | Content ID, DCID, |
| | | | conforming to the State |
| | | | Administration of Radio Film |
| | | | and television standard GY/T |
| | | | 260-2012 “radio and |
| | | | television digital rights |
| | | | management of digital |
| | | | content identifier” |
| Encryption_Algorithm | 8 | Uimsbf | Content encryption algorithm |
| Key_Length | 16 | Uimsbf | Decryption key length |
| Key[ ] | N*8 | Uimsbf | Decryption key, using |
| | | | encryption protection to |
| | | | ensure confidentiality to all |
| | | | unauthorized objects |
| } | | | |

(6) The object descriptor is used for describing the authorized object, and there must be at least one and may be multiple. It is defined as follows:

### Object Descriptor

| | Bit | | |
|---|---|---|---|
| Field | number | Type | Description |
| Oject_Descriptor{ | | | |
| Tag | 16 | Uimsbf | 0x2001 |
| Length | 16 | Uimsbf | |
| Device_ID_Length | 8 | Uimsbf | Object ID length |
| Device_ID[ ] | N*8 | Uimsbf | Object ID |
| } | | | |

(7) The right descriptor is used for describing the right description needing to participate in operation, and there must be at least one and may be multiple. The right descriptor includes: a count descriptor, a duration descriptor, a time slot descriptor, a content quality descriptor, a parental control rule descriptor, a display rule descriptor, a display screen resolution rule descriptor, a region descriptor, a super right descriptor, a content play right descriptor, a content recording rule descriptor, a content forwarding rule descriptor, a content copying descriptor, a content modification rule descriptor, a right storage rule descriptor, a right forwarding rule descriptor, a right execution descriptor and the like, which are defined as follows:

### Count Descriptor

| Field | Bit number | Type | Description |
|---|---|---|---|
| Count_Descriptor{ | | | |
| Tag | 16 | Uimsbf | 0x3001 |
| Length | 16 | Uimsbf | |
| Count | 32 | Uimsbf | Play count |
| } | | | |

When being used singly, the right descriptor is used for further limiting the existing rights of the object according to count.

### Duration Descriptor

| Field | Bit number | Type | Description |
|---|---|---|---|
| Duration_Descriptor{ | | | |
| Tag | 16 | Uimsbf | 0x3002 |
| Length | 16 | Uimsbf | |
| Duration | 32 | Uimsbf | Play duration |
| } | | | |

When being used singly, the right descriptor is used for further limiting the existing rights of the object according to duration.

### Time Slot Descriptor

| Field | Bit number | Type | Description |
|---|---|---|---|
| TimeSlot_Descriptor{ | | | |
| Tag | 16 | Uimsbf | 0x3003 |
| Length | 16 | Uimsbf | |
| StartTime | 64 | Uimsbf | Start time, UTC time |
| EndTime | 64 | Uimsbf | End time, UTC time |
| } | | | |

When being used singly, the right descriptor is used for further limiting the existing rights of the object according to time slot.

### Region Descriptor

| Field | Bit number | Type | Description |
|---|---|---|---|
| Region_Descriptor{ | | | |
| Tag | 16 | Uimsbf | 0x3004 |
| Length | 16 | Uimsbf | |
| Region_ID | 32 | Uimsbf | Region ID |
| } | | | |

When being used singly, the right descriptor is used for further limiting the existing rights of the object according to region.

### Content Quality Descriptor

| | Bit | | |
|---|---|---|---|
| Field | number | Type | Description |
| ContentQuality_Descriptor{ | | | |
| Tag | 16 | Uimsbf | 0x03011 |
| Length | 16 | Uimsbf | |
| Quality | 8 | Uimsbf | Content quality (0: |
| | | | all; 1: standard |
| | | | definition; 2: high |
| | | | definition; 3: ultrahigh |
| | | | definition) |
| } | | | |

When being used singly, the right descriptor is used for further limiting the existing rights of the object according to content quality.

### Parental Control Rule Descriptor

| | Bit | | |
|---|---|---|---|
| Field | number | Type | Description |
| ParentRules_Descriptor{ | | | |
| Tag | 16 | Uimsbf | 0x3012 |
| Length | 16 | Uimsbf | |
| ParentLevel | 8 | Uimsbf | Patient control |
| | | | level |
| } | | | |

When being used singly, the right descriptor is used for further limiting the existing rights of the object according to a Parental control rule.

### Display Rule Descriptor

| | Bit | | |
|---|---|---|---|
| Field | number | Type | Description |
| DisplayLevelRules_Descriptor{ | | | |
| Tag | 16 | Uimsbf | 0x3013 |
| Length | 16 | Uimsbf | |
| DisplayLevel | 8 | Uimsbf | Display level (0: |
| | | | mobile |
| | | | phone/PAD; 1: |
| | | | HDMI; 2: large |
| | | | screen, high level |
| | | | can support low |
| | | | level) |
| } | | | |

When being used singly, the right descriptor is used for further limiting the existing rights of the object according to a display rule.

### Display Screen Resolution Rule Descriptor

| Field | Bit number | Type | Description |
|---|---|---|---|
| DisplayRules_Descriptor{ | | | |
| Tag | 16 | Uimsbf | 0x3014 |
| Length | 16 | Uimsbf | |
| ScreenWidth | 16 | Uimsbf | Screen resolution |
| | | | width |
| ScreenHeight | 16 | Uimsbf | Screen resolution |
| | | | height |
| } | | | |

When being used singly, the right descriptor is used for further limiting the existing rights of the object according to a display resolution rule.

### Super Right Descriptor

| Field | Bit number | Type | Description |
|---|---|---|---|
| Super_Descriptor{ | | | |
| Tag | 16 | Uimsbf | 0x3000 |
| Length | 16 | Uimsbf | |
| } | | | |

The right descriptor owns all rights under the version.

### Content Play Right Descriptor

| Field | Bit number | Type | Description |
|---|---|---|---|
| PlayRight_Descriptor{ | | | |
| Tag | 16 | Uimsbf | 0x3021 |
| Length | 16 | Uimsbf | 0 |
| } | | | |

### Content Recording Rule Descriptor

| Field | Bit number | Type | Description |
|---|---|---|---|
| RecordRules_Descriptor{ | | | |
| Tag | 16 | Uimsbf | 0x03022 |
| Length | 16 | Uimsbf | 0 |
| } | | | |

### Content Forwarding Rule Descriptor

| Field | Bit number | Type | Description |
|---|---|---|---|
| TransferRules_Descriptor{ | | | |
| Tag | 16 | Uimsbf | 0x3023 |
| Length | 16 | Uimsbf | 0 |
| } | | | |

### Content Copying Descriptor

| Field | Bit number | Type | Description |
|---|---|---|---|
| CopyRules_Descriptor{ | | | |
| Tag | 16 | Uimsbf | 0x3024 |
| Length | 16 | Uimsbf | 0 |
| } | | | |

### Content Modification Rule Descriptor

| Field | Bit number | Type | Description |
|---|---|---|---|
| ModifyRules_Descriptor{ | | | |
| Tag | 16 | Uimsbf | 0x3025 |
| Length | 16 | Uimsbf | 0 |
| } | | | |

### Right Storage Rule Descriptor

| Field | Bit number | Type | Description |
|---|---|---|---|
| RightStoreRules_Descriptor{ | | | |
| Tag | 16 | Uimsbf | 0x3026 |
| Length | 16 | Uimsbf | 0 |
| } | | | |

### Right Forwarding Rule Descriptor

| Field | Bit number | Type | Description |
|---|---|---|---|
| RightTransferRules_Descriptor{ | | | |
| Tag | 16 | Uimsbf | 0x3027 |
| Length | 16 | Uimsbf | 0 |
| } | | | |

### Execution Right Descriptor

| Field | Bit number | Type | Description |
|---|---|---|---|
| ExecuteRight_Descriptor{ | | | |
| Tag | 16 | Uimsbf | 0x3028 |
| Length | 16 | Uimsbf | 0 |
| } | | | |

(8) As for the calculator descriptor for describing a right operation method, thereby may be none, and if there is none, all of the above-mentioned descriptors form AND relationship. The calculator descriptor is used for describing the index numbers of the descriptors participating in the operation, the index numbers are sequentially numbered according to the position sequences of the descriptors in a content right descriptor and are numbered from 0, the logical operator is numbered as well and can also be quoted by the subsequent logical operator so as to achieve iterative operation, and it is defined as follows:

### Logical Operation Descriptor

| | Bit | | |
|---|---|---|---|
| Field | number | Type | Description |
| LogicOperation_Descriptor{ | | | |
| Tag | 16 | Uimsbf | 0x4001:AND |
| | | | operation; |
| | | | 0x4002:OR |
| | | | operation; |
| | | | 0x4003:NOT |
| | | | operation; |
| | | | 0x4004:XOR |
| | | | operation |
| Length | 16 | Uimsbf | |
| RightsIndex_Length | | | Index lengths of |
| | | | descriptors |
| | | | participating in |
| | | | the operation |
| For(i=0;i< m,i++){ | | | |
| RightsIndex | 8 | | Indexes of the |
| | | | descriptors |
| | | | participating in |
| | | | the operation |
| } | | | |
| } | | | |

(9) The signature descriptor is used for signing the entire data structure to ensure the entirety of the data. It is defined as follows:

### Signature Descriptor

| | Bit | | |
|---|---|---|---|
| Field | number | Type | Description |
| Signature_Descriptor{ | | | |
| Tag | 16 | Uimsbf | 0x5001 |
| Length | 16 | Uimsbf | |
| Algorithm | 8 | Uimsbf | Signature |
| | | | algorithm |
| Certification_ID | 64 | Uimsbf | Signature |
| | | | certificate |
| | | | serial number, |
| | | | unique serial |
| | | | number |
| Signature_Length | 16 | Uimsbf | Signature |
| | | | length |
| Signature[ ] | N*8 | Uimsbf | Signature |
| } | | | |

To obtain the right of a certain object for a certain content, the right formula needs to be established according to the logical operator in the content right descriptor to calculate the content rights.

To illustrate the right operation method more clearly, examples are as follows:

A user 1 and a user 2 are allowed to use a mobile phone 1 and a set top box 2 to watch a program 1 and a program 2 in a region 1, the program 1 is allowed to be output to HDMI, and the program 2 is not allowed to be output to HDMI.

If a common content right description language is used, the following rights need to be described:

1. the user 1 is allowed to use the mobile phone 1 to watch the program 1 in the region 1, and the program 1 is allowed to be output to HDMI;

2. the user 1 is allowed to use the mobile phone 1 to watch the program 2 in the region 1, and the program 2 is allowed to be output to HDMI;

3. the user 1 is allowed to use the set top box 2 to watch the program 1 in the region 1, and the program 1 is allowed to be output to HDMI;

4. the user 1 is allowed to use the set top box 2 to watch the program 2 in the region 1, and the program 2 is not allowed to be output to HDMI;

5. the user 2 is allowed to use the mobile phone 1 to watch the program 1 in the region 1, and the program 1 is allowed to be output to HDMI;

6. the user 2 is allowed to use the mobile phone 1 to watch the program 2 in the region 1, and the program 2 is allowed to be output to HDMI;

7. the user 2 is allowed to use the set top box 2 to watch the program 1 in the region 1, and the program 1 is allowed to be output to HDMI;

8. the user 2 is allowed to use the set top box 2 to watch the program 2 in the region 1, and the program 2 is not allowed to be output to HDMI.

A right packaging method provided by the present invention is adopted as follows:

A. the content is the program 1 (Program 1) and the program 2 (Program 2);

B. the object is the user 1 (User 1), the user 2 (User 2), the mobile phone 1 (Phone 1), the set top box 2 (STB 2);

C. the right is the region 1 (Region 1), watching (play, Play), outputting to HDMI (Display Level).

D. right operation: right formula=(Program 1l or Program 2) and (User 1 or User2) and (Phone 1 or STB 2) and (Region 1) and (Play) and (((Program 1 and DisplayLevel) or (Program 2 and (Not DisplayLevel))).

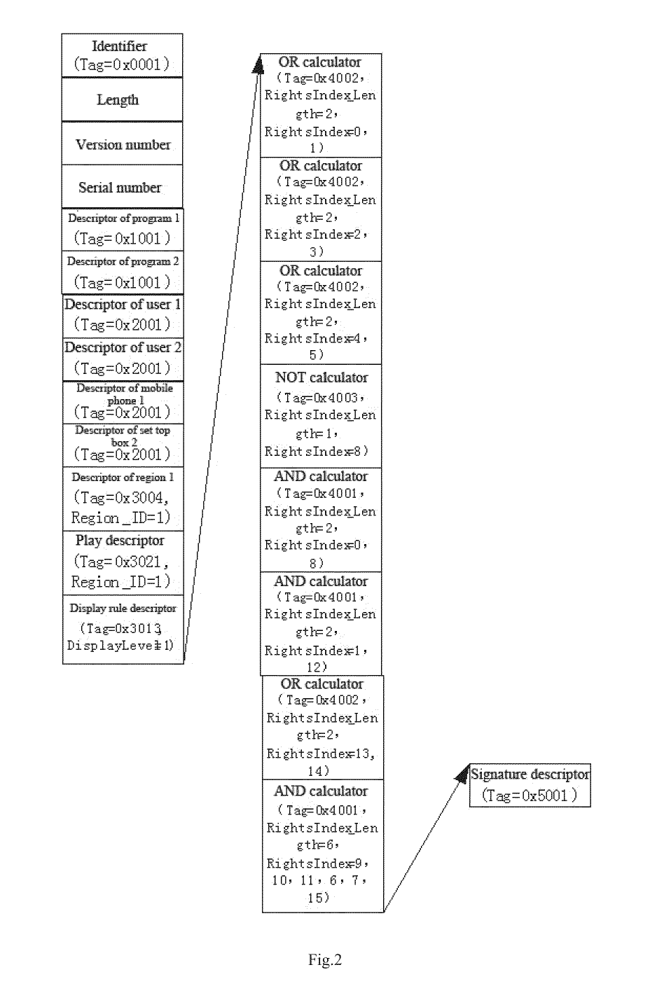

FIG. 2 is a content right description completed according to the right formula by using the right operation method. The Tag value of the right description is 0x0001.

1. A content descriptor is defined firstly.

A. The Tag of the descriptor of the program 1 is 0x1001, and RightsIndex in the right description is 0;

B. the Tag of the descriptor of the program 2 is 0x1001, and RightsIndex in the right description is 1.

2. An object descriptor is defined.

A. The Tag of the descriptor of the user 1 is 0x2001, and RightsIndex in the right description is 2;

B. the Tag of the descriptor of the user 2 is 0x2001, and RightsIndex in the right description is 3;

C. the Tag of the descriptor of the mobile phone 1 is 0x2001, and RightsIndex in the right description is 4;

D. the Tag of the descriptor of the set top box 2 is 0x2001, and RightsIndex in the right description is 5.

3. A right descriptor is defined.

A. The Tag of the descriptor of the region 1 is 0x3004, and RightsIndex in the right description is 6;

B. the Tag of the play descriptor defining the program watching right is 0x3021, and RightsIndex in the right description is 7;

C. the Tag of the display rule descriptor defining the display manner is 0x3013, DisplayLevel is 1 to express supporting HDMI display, and RightsIndex in the right description is 8.

4. A calculator is defined for describing the operation relationship of the rights to describe the right formula.

A. An OR calculator is defined, wherein Tag is 0x4002, RightsIndex_length is two bytes, the RightsIndex numbers of the operation are 0 and 1 to express that OR operation is performed on the descriptor of the program 1 and the descriptor of the program 2 and express the program 1 and the program 2, and the RightsIndex in the right description is 9.

B. An OR calculator is defined, wherein Tag is 0x4002, RightsIndex_length is two bytes, the RightsIndex numbers of the operation are 2 and 3 to express that OR operation is performed on the descriptor of the user 1 and the descriptor of the user 2 and express the user 1 and the user 2, and the RightsIndex in the right description is 10.

C. An OR calculator is defined, wherein Tag is 0x4002, RightsIndex_length is two bytes, the RightsIndex numbers of the operation are 4 and 5 to express that OR operation is performed on the descriptor of the mobile phone 1 and the descriptor of the set top box 2 and express the mobile phone 1 and the set top box 2, and the RightsIndex in the right description is 11.

D. A NOT calculator is defined, wherein Tag is 0x4003, RightsIndex_length is one byte, the RightsIndex number of the operation is 8 to express that NOT operation is performed on the content display rule descriptor and express that displaying on HDMI is prohibited, and the RightsIndex in the right description is 12.

E. An AND calculator is defined, wherein Tag is 0x4001, RightsIndex_length is two bytes, the RightsIndex numbers of the operation are 0 and 8 to express that OR operation is performed on the descriptor of a content 1 and the display rule descriptor and express that the content 1 is allowed to be displayed on HDMI, and the RightsIndex in the right description is 13.

F. An AND calculator is defined, wherein Tag is 0x4001, RightsIndex_length is two bytes, the RightsIndex numbers are of the operation 1 and 12 to express that OR operation is performed on the descriptor of a content 2 and a NOT calculator descriptor and express that the content 2 is prohibited to be displayed on HDMI, and the RightsIndex in the right description is 14.

G. An OR calculator is defined, wherein Tag is 0x4002, RightsIndex_length is two bytes, the RightsIndex numbers of the operation are 13 and 14 to express that OR operation is performed on the calculator descriptors and express that the content 1 is allowed to be displayed on HDMI and the content 2 is prohibited to be displayed on HDMI, and the RightsIndex in the right description is 15.

H. An AND calculator is defined, wherein Tag is 0x4001, RightsIndex_length is six bytes, the calculated RightsIndex numbers of the operation are 9, 10, 11, 6, 7 and 15 to express that AND operation is performed on the calculator descriptors and express that the program 1 and the program 2 are allowed to be displayed by the user 1 and the user 2 on the mobile phone 1 and the set top box 2 in the region 1, the content 1 is allowed to be displayed on HDMI and the content 2 is prohibited to be displayed on HDMI, and the RightsIndex in the right description is 16.

The content right description is completed.

It can be seen from the above-mentioned content right packaging that, the right operation method can follow common language habits and is simpler, more convenient, more efficient and more flexible than a common content right description language. Meanwhile, by adopting a Tag, a universal descriptor analyzer can be used for analyzing the content rights, and different versions only need to be analyzed according to the definition of the descriptor. When upgrading the version, only a new Tag needs to be added, in this way, when meeting a high-version tag, a low-version analyzer can still work normally except that the high-version tag cannot be identified. A high-version analyzer can ensure the normal analysis of the rights as long as all tags can be identified. Therefore, effective interaction between front ends and terminals of different versions can be achieved to improve the interoperability of the system.

### Embodiment 2

Rights can be merged to redefine the right description. They are defined as follows:

### Count Right Descriptor

| | Bit | | |
|---|---|---|---|
| Field | number | Type | Description |
| RightCount_Descriptor{ | | | |
| Tag | 16 | Uimsbf | 0x6001 |
| Length | 16 | Uimsbf | |
| PlayFlag | 1 | Uimsbf | Play right: 0: unauthorized; |
| | | | 1: authorized |
| ContentRecFlag | 1 | Uimsbf | Content recording right: 0: |
| | | | unauthorized; 1: authorized |
| ContentTimeShiftFlag | 1 | Uimsbf | Content time shift right: 0: |
| | | | unauthorized; 1: authorized |
| ContentStoreFlag | 1 | Uimsbf | Content storage right: 0: |
| | | | unauthorized; 1: authorized |
| ContentTransferFlag | 1 | Uimsbf | Content transmission right: |
| | | | 0: unauthorized; |
| | | | 1: authorized |
| RightStoreFlag | 1 | Uimsbf | Right storage right: 0: |
| | | | unauthorized; 1: authorized |
| RightTransferFlag | 1 | Uimsbf | Right transmission right: 0: |
| | | | unauthorized; 1: authorized |
| Count | 32 | Uimsbf | Count |
| LastCount | 32 | Uimsbf | Last count |
| } | | | |

### Duration Right Descriptor

| | Bit | | |
|---|---|---|---|
| Field | number | Type | Description |
| RightDuration_Descriptor{ | | | |
| Tag | 16 | Uimsbf | 0x6002 |
| Length | 16 | Uimsbf | |
| PlayFlag | 1 | Uimsbf | Play right: 0: |
| | | | unauthorized; |
| | | | 1: authorized |
| ContentRecFlag | 1 | Uimsbf | Content |
| | | | recording right: |
| | | | 0: unauthorized; |
| | | | 1: authorized |
| ContentTimeShiftFlag | 1 | Uimsbf | Content time |
| | | | shift right: 0: |
| | | | unauthorized; |
| | | | 1: authorized |
| ContentStoreFlag | 1 | Uimsbf | Content |
| | | | storage right: |
| | | | 0: unauthorized; |
| | | | 1: authorized |
| ContentTransferFlag | 1 | Uimsbf | Content |
| | | | transmission |
| | | | right: 0: |
| | | | unauthorized; |
| | | | 1: authorized |
| RightStoreFlag | 1 | Uimsbf | Right storage |
| | | | right 0: |
| | | | unauthorized; |
| | | | 1: authorized |
| RightTransferFlag | 1 | Uimsbf | Right |
| | | | transmission |
| | | | right: 0: |
| | | | unauthorized; |
| | | | 1: authorized |
| Duration | 32 | Uimsbf | Duration |
| LastDuration | 32 | Uimsbf | Last duration |
| } | | | |

### Time Slot Descriptor

| | Bit | | |
|---|---|---|---|
| Field | number | Type | Description |
| RightTimeSlot_Descriptor{ | | | |
| Tag | 16 | Uimsbf | 0x6003 |
| Length | 16 | Uimsbf | |
| PlayFlag | 1 | Uimsbf | Play right: 0: |
| | | | unauthorized; |
| | | | 1: authorized |
| ContentRecFlag | 1 | Uimsbf | Content recording |
| | | | right: 0: unauthorized; |
| | | | 1: authorized |
| ContentTimeShiftFlag | 1 | Uimsbf | Content time shift |
| | | | right: 0: unauthorized; |
| | | | 1: authorized |
| ContentStoreFlag | 1 | Uimsbf | Content storage right: |
| | | | 0: unauthorized; |
| | | | 1: authorized |
| ContentTransferFlag | 1 | Uimsbf | Content transmission |
| | | | right: 0: unauthorized; |
| | | | 1: authorized |
| RightStoreFlag | 1 | Uimsbf | Right storage right |
| | | | 0: unauthorized; |
| | | | 1: authorized |
| RightTransferFlag | 1 | Uimsbf | Right transmission |
| | | | right: 0: unauthorized; |
| | | | 1: authorized |
| StartTime | 64 | Uimsbf | Start time, UTC time |
| EndTime | 64 | Uimsbf | End time, UTC time |
| } | | | |

To obtain the right of a certain object for a certain content, the right formula needs to be established according to the logical operator in the content right descriptor to calculate the content rights.

Examples are as follows:

### Example 1

a user 1 is allowed to play a program 1 according to count and can play for 10 times;

the user 1 is allowed to play, record, time shift, store and transmit contents;

the user 1 is allowed to store and transmit rights.

A right packaging method provided by the present invention is adopted as follows:

A. the content is the program 1 (Program 1);

B. the object is the user 1 (User 1);

C. the right is a count right 1 (Right Count 1);

D. right operation: right formula=(Program 1) and (User 1) and (Right Count 1).

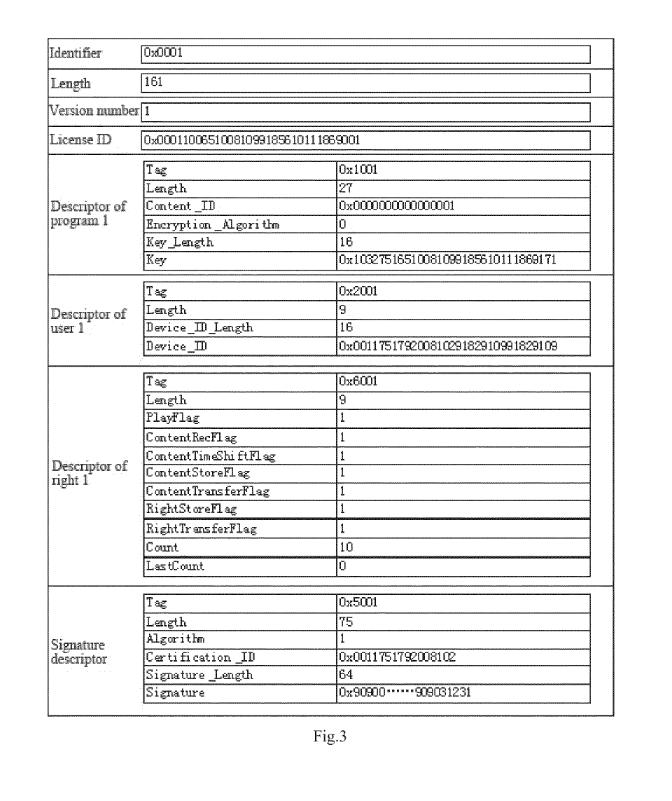

FIG. 3 is a content right description completed according to the right formula by using the right operation method. The Tag value of the right description is 0x0001.

1. A content descriptor is defined.

The Tag of the descriptor of the program 1 is 0x0001, and RightsIndex in the right description is 0.

2. An object descriptor is defined.

The Tag of the descriptor of the user 1 is 0x2001, and RightsIndex in the right description is 1.

3. A right descriptor is defined.

The Tag of the descriptor of the right 1 is 0x6001, and RightsIndex in the right description is 2.

The content right description is completed, since there is no calculator descriptor in the description, all of the above-mentioned descriptors form AND relationship, and the content rights can be calculated by means of the right formula=(program 1 descriptor) and (user 1 descriptor) and (right 1 descriptor).

### Example 2

a user 1 and a user 2 are allowed to play a program 1 and a program 2 according to count and can play for 100 times;

the user 1 and the user 2 are allowed to play the program 1 and the program 2 according to duration and can play for 1000 seconds;

the user 1 and the user 2 are allowed to play the program 1 and the program 2 according to time slot, and the play time slot is 2012-08-22 10:00:00 to 2013-08-22 10:00:00;

the user 1 and the user 2 are allowed to play, record, time shift and store contents;

the user 1 and the user 2 are not allowed to transmit the contents;

the user 1 and the user 2 are not allowed to store or transmit rights.

A right packaging method provided by the present invention is adopted as follows:

A. the content is the program 1 (Program 1) and the program 2 (Program 2)

B. the object is the user 1 (User 1) and the user 2 (User 2)

C. the right is a count right 1 (Right 1), a duration right 2 (Right 2) and a time slot right 3 (Right 3).

D. right operation: right formula=(Program 1 or Program 2) and (User 1 or User 2) and (Right 1 or Right 2 or Right 3).

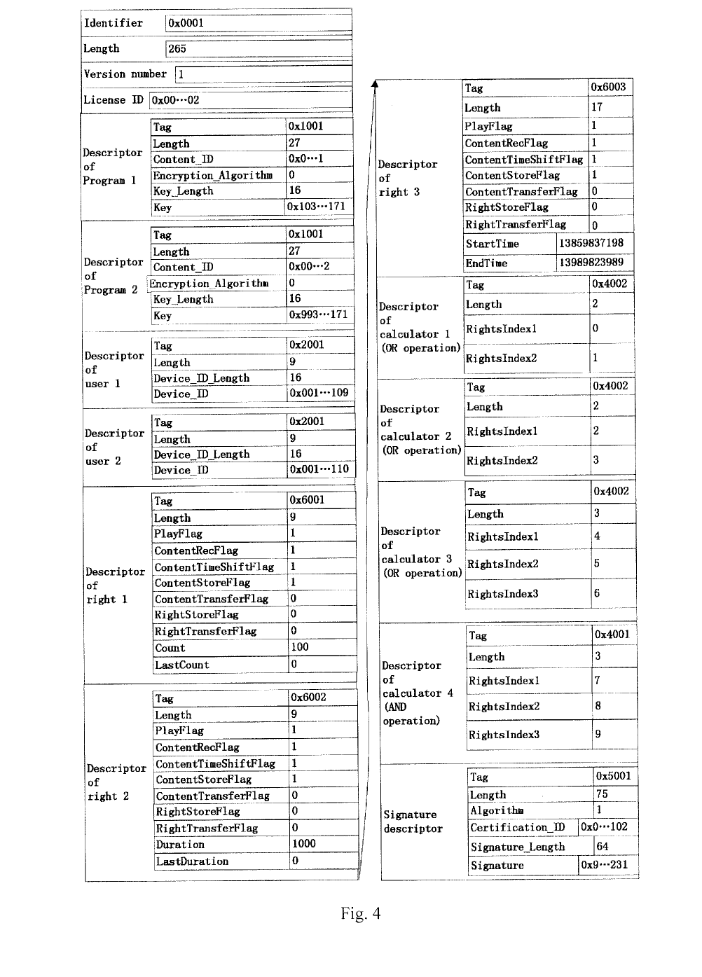

FIG. 4 is a content right description completed according to the right formula by using the right operation method. The Tag value of the right description is 0x0001.

1. A content descriptor is defined.

The Tag of the descriptor of the program 1 is 0x0001, and RightsIndex in the right description is 0.

The Tag of the descriptor of the program 2 is 0x0001, and RightsIndex in the right description is 1.

2. An object descriptor is defined.

The Tag of the descriptor of the user 1 is 0x2001, and RightsIndex in the right description is 2.

The Tag of the descriptor of the user 2 is 0x2001, and RightsIndex in the right description is 3.

3. A right descriptor is defined.

The Tag of the descriptor of the right 1 is 0x6001, and RightsIndex in the right description is 4.

The Tag of the descriptor of the right 2 is 0x6002, and RightsIndex in the right description is 5.

The Tag of the descriptor of the right 3 is 0x6003, and RightsIndex in the right description is 6.

4. An calculator descriptor is defined.

The Tag of the descriptor of a calculator 1 is 0x4001, and RightsIndex in the right description is 7.

The Tag of the descriptor of a calculator 2 is 0x4001, and RightsIndex in the right description is 8.

The Tag of the descriptor of a calculator 3 is 0x4001, and RightsIndex in the right description is 9.

The Tag of the descriptor of a calculator 4 is 0x4001, and RightsIndex in the right description is 10.

The content right description is completed, there is the calculator descriptor in the description, and calculation is performed according to the calculator description:

the descriptor of the calculator 1 is OR operation and is the descriptor of the program 1 (RightsIndex is equal to 0) or the descriptor of the program 2 (RightsIndex is equal to 1);

the descriptor of the calculator 2 is OR operation and is the descriptor of the user 1 (RightsIndex is equal to 2) or the descriptor of the user 2 (RightsIndex is equal to 3);

the descriptor of the calculator 3 is OR operation and is the descriptor of the right 1 (RightsIndex is equal to 4) or the descriptor of the right 2 (RightsIndex is equal to 5) or the descriptor of the right 3 (RightsIndex is equal to 6);

the descriptor of the calculator 4 is AND operation and is the descriptor of the calculator 1 (RightsIndex is equal to 7), and the descriptor of the calculator 2 (RightsIndex is equal to 8) and the descriptor of the calculator 3 (RightsIndex is equal to 9).

Therefore, the content rights can be calculated according to the right formula=(the descriptor of the program 1 or the descriptor of the program 2) and (the descriptor of the user 1 or the descriptor of the user 2) and (the descriptor of the right 1 or the descriptor of the right 2 or the descriptor of the right 3).

It can be seen from the above-mentioned content right packaging that, the right description can be used for merging rights with the right range, and can be used for defining applicable right Tag according to demand on specific application occasions, to ensure more concise and more efficient processing.

### Embodiment 3

The right descriptor is expanded, and the rights are described in a simple manner to ensure easier right processing according to count, duration, time slot, content, right storage and transmission and the like. It is defined as follows:

### Right Descriptor

| | Bit | | |
|---|---|---|---|
| Field | number | Type | Description |
| Right_Descriptor{ | | | |
| Tag | 16 | Uimsbf | 0x7001 |
| Length | 16 | Uimsbf | |
| PlayFlag | 8 | Uimsbf | Play flag: 1: according |
| | | | to count or duration; |
| | | | 2: according to time slot |
| PlayMethod | 8 | Uimsbf | Play manner: 1. play |
| | | | according to count; |
| | | | 2: play according to |
| | | | duration |
| If(PlayFlag == 1) { | | | |
| If(PlayMethod == 1) { | | | |
| PlayCount | 32 | Uimsbf | Play count |
| LastPlayCount | 32 | Uimsbf | Last play count |
| } else if (PlayMethod == 2) | | | |
| { | | | |
| PlayTitne | 32 | Uimsbf | Play time |
| LastPlayCount | 32 | Uimsbf | Last play count, with |
| | | | unit of second |
| } | | | |
| } else if(PlayFlag == 2) { | | | |
| PlayStartTime | 64 | Uimsbf | Play start time, UTC time |
| PlayEndTime | 64 | Uimsbf | Play end time, UTC time |
| } | | | |
| ContentRecFlag | 1 | Uimsbf | Content recording flag: |
| | | | 0: unauthorized; |
| | | | 1: authorized |
| ContentTimeShiftFlag | 1 | Uimsbf | Content time shift flag: |
| | | | 0: unauthorized; |
| | | | 1: authorized |
| ContentStoreFlag | 1 | Uimsbf | Content storage flag: |
| | | | 0: unauthorized; |
| | | | 1: authorized |
| ContentTransferFlag | 1 | Uimsbf | Content transmission |
| | | | flag: 0: unauthorized; |
| | | | 1: authorized |
| RightStoreFlag | 1 | Uimsbf | Right storagee flag: |
| | | | 0: unauthorized; |
| | | | 1: authorized |
| RightTransferFlag | 1 | Uimsbf | Right transmission flag: |
| | | | 0: unauthorized; |
| | | | 1: authorized |
| ParentControlFlag | 8 | Uimsbf | Parental control level: |
| | | | 0:U level, common level |
| | | | 5:UC level, especially |
| | | | suitable for children |
| | | | 8:PG level, parental |
| | | | guide level; |
| | | | 12:12 level, suitable for |
| | | | being watched by ones |
| | | | more than 12 years old |
| | | | 15:15 level, suitable for |
| | | | being watched by ones |
| | | | more than 15 years old |
| | | | 18:18 level, suitable for |
| | | | being watched by ones |
| | | | more than 18 years old |
| } | | | |

To obtain the right of a certain object for a certain content, the right formula needs to be established according to the logical operator in the content right descriptor to calculate the content rights.

Examples are as follows:

### Example 1

a user 1 is allowed to play a program 1 according to count and can play for 10 times;

the user 1 is allowed to record, time shift and store contents;

the user 1 is not allowed to transmit contents;

the user 1 is not allowed to store or transmit rights.

A right packaging method provided by the present invention is adopted as follows:

A. the content is the program 1 (Program 1);

B. the object is the user 1 (User 1);

C. the right is a right 1 (Right 1);

D. right operation: right formula=(Program 1) and (User 1) and (Right 1).

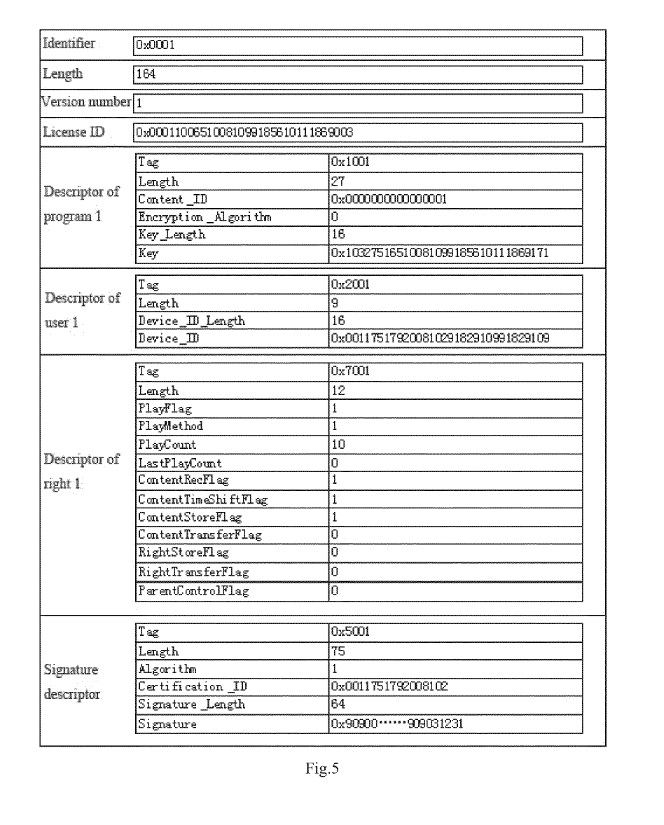

FIG. 5 is a content right description completed according to the right formula by using the right operation method. The Tag value of the right description is 0x0001.

1. A content descriptor is defined.

The Tag of the descriptor of the program 1 is 0x0001, and RightsIndex in the right description is 0.

2. An object descriptor is defined.

The Tag of the descriptor of the user 1 is 0x2001, and RightsIndex in the right description is 1.

3. A right descriptor is defined.

The Tag of the descriptor of the right 1 is 0x7001, and RightsIndex in the right description is 2.

The content right description is completed, since there is no calculator descriptor in the description, all of the above-mentioned descriptors form AND relationship, and the content rights can be calculated by means of the right formula=(the descriptor of the program 1) and (the descriptor of the user 1) and (the descriptor of the right 1).

### Example 2

A user 1 is allowed to play a program 1 and a program 2 according to duration and can play for 1000 seconds;

the user 1 is allowed to record, time shift and store contents;

the user 1 is not allowed to transmit the contents;

the user 1 is not allowed to store or transmit rights.

A right packaging method provided by the present invention is adopted as follows:

A. the content is the program 1 (Program 1) and the program 2 (Program 2)

B. the object is the user 1 (User 1);

C. the right is a right 1 (Right 1).

D. right operation: right formula=(Program 1 or Program 2) and (User 1) and (Right 1).

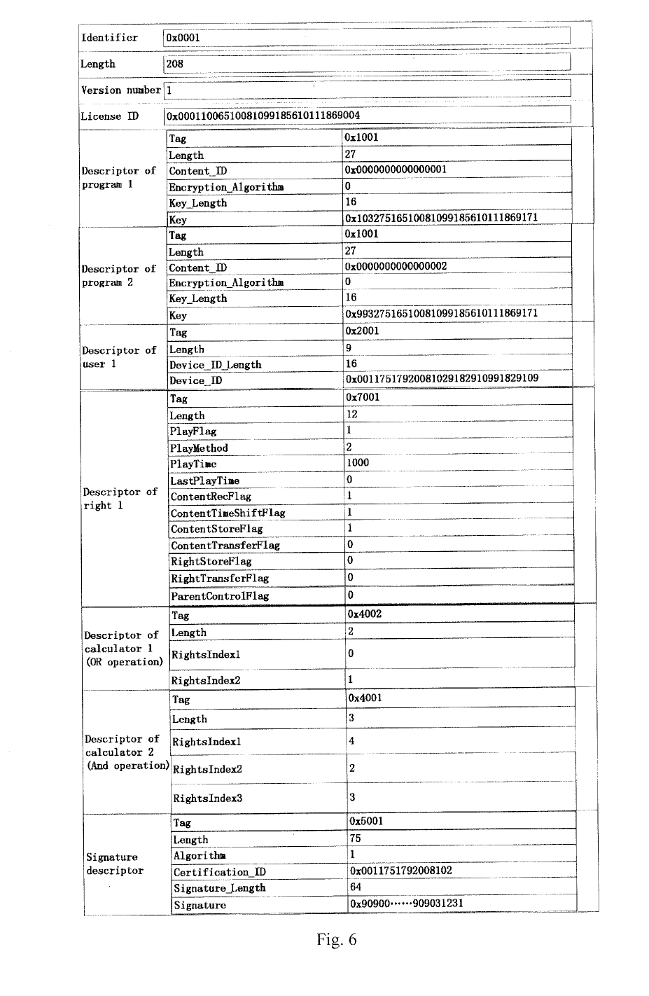

FIG. 6 is a content right description completed according to the right formula by using the right operation method. The Tag value of the right description is 0x0001.

1. A content descriptor is defined.

The Tag of the descriptor of the program 1 is 0x0001, and RightsIndex in the right description is 0.

The Tag of the descriptor of the program 2 is 0x0001, and RightsIndex in the right description is 1.

2. An object descriptor is defined.

The Tag of the descriptor of the user 1 is 0x2001, and RightsIndex in the right description is 2.

3. A right descriptor is defined.

The Tag of the descriptor of the right 1 is 0x7001, and RightsIndex in the right description is 3.

4. An calculator descriptor is defined.

The Tag of the descriptor of a calculator 1 is 0x4001, and RightsIndex in the right description is 4.

The Tag of the descriptor of a calculator 2 is 0x4001, and RightsIndex in the right description is 5.

The content right description is completed, there is the calculator descriptor in the description, and calculation is performed according to the calculator description:

the descriptor of the calculator 1 is OR operation and is the descriptor of the program 1 (RightsIndex is equal to 0) or the descriptor of the program 2 (RightsIndex is equal to 1);

the descriptor of the calculator 2 is AND operation and is the descriptor of the calculator 1 (RightsIndex is equal to 4), and the descriptor of the user 1 (RightsIndex is equal to 2) and the descriptor of the right 1 (RightsIndex is equal to 3).

Therefore, the content rights can be calculated according to the right formula=(the descriptor of the program 1 or the descriptor of the program 2) and (the descriptor of the user 1) and (the descriptor of the right 1).

It can be seen from the above-mentioned content right packaging that, the right description can be concisely defined and can be used for defining applicable right Tag according to demand on specific application occasions, to ensure more concise and more efficient processing.

### Embodiment 4

The right descriptor is expanded, and the right ranges of play, storage, copy, forwarding, execution and the like are defined, such that the data size of the right information is smaller, the efficiency is higher and the application is wider. It is defined as follows:

### Count Play Right Descriptor

| Field | Bit number | Type | Description |
|---|---|---|---|
| PlayCount_Descriptor{ | | | |
| Tag | 16 | Uimsbf | 0x8001 |
| Length | 16 | Uimsbf | |
| PlayCount | 32 | Uimsbf | Play count |
| } | | | |

### Duration Play Right Descriptor

| Field | Bit number | Type | Description |
|---|---|---|---|
| PlayDuration_Descriptor{ | | | |
| Tag | 16 | Uimsbf | 0x8002 |
| Length | 16 | Uimsbf | |
| PlayDuration | 32 | Uimsbf | Play duration |
| } | | | |

### Time Slot Play Right Descriptor

| | Bit | | |
|---|---|---|---|
| Field | number | Type | Description |
| PlayTimeSlot_Descriptor{ | | | |
| Tag | 16 | Uimsbf | 0x8003 |
| Length | 16 | Uimsbf | |
| PlayStartTime | 64 | Uimsbf | Play start |
| | | | time, UTC |
| | | | time |
| PlayEndTIme | 64 | Uimsbf | Play end time, |
| | | | UTC time |
| } | | | |

### Region Play Right Descriptor

| | Bit | | |
|---|---|---|---|
| Field | number | Type | Description |
| PlayRegion_Descriptor{ | | | |
| Tag | 16 | Uimsbf | 0x8004 |
| Length | 16 | Uimsbf | |
| Play_Region_ID | 32 | Uimsbf | Play region ID |
| } | | | |

### Quality Play Right Descriptor

| | Bit | | |
|---|---|---|---|
| Field | number | Type | Description |
| PlayQuality_Descriptor{ | | | |
| Tag | 16 | Uimsbf | 0x8005 |
| Length | 16 | Uimsbf | |
| Play_Quality | 8 | Uimsbf | Play quality |
| | | | (0: all; |
| | | | 1: standard |
| | | | definition; |
| | | | 2: high |
| | | | definition; |
| | | | 3: ultrahigh |
| | | | definition) |
| } | | | |

### Display Play Right Descriptor

| | Bit | | |
|---|---|---|---|
| Field | number | Type | Description |
| PlayDisplayLevel_Descriptor{ | | | |
| Tag | 16 | Uimsbf | 0x8006 |
| Length | 16 | Uimsbf | |
| Play_DisplayLevel | 8 | Uimsbf | Play display |
| | | | level (0: mobile |
| | | | phone/PAD; |
| | | | 1: HDMI; |
| | | | 2: large screen, |
| | | | high level can |
| | | | support low |
| | | | level) |
| } | | | |

### Screen Resolution Play Right Descriptor

| | Bit | | |
|---|---|---|---|
| Field | number | Type | Description |
| PlayScreen_Descriptor{ | | | |
| Tag | 16 | Uimsbf | 0x8007 |
| Length | 16 | Uimsbf | |
| Play_ScreenWidth | 16 | Uimsbf | Screen |
| | | | resolution |
| | | | width, unit: |
| | | | pixel |
| Play_ScreenHeight | 16 | Uimsbf | Screen |
| | | | resolution |
| | | | height, unit: |
| | | | pixel |
| } | | | |

### Count Record Right Descriptor

| | Bit | | |
|---|---|---|---|
| Field | number | Type | Description |
| RecordCount_Descriptor{ | | | |
| Tag | 16 | Uimsbf | 0x8101 |
| Length | 16 | Uimsbf | |
| RecordCount | 32 | Uimsbf | Record count |
| } | | | |

### Duration Record Right Descriptor

| | Bit | | |
|---|---|---|---|
| Field | number | Type | Description |
| RecordDuration_Descriptor{ | | | |
| Tag | 16 | Uimsbf | 0x8102 |
| Length | 16 | Uimsbf | |
| RecordDuration | 32 | Uimsbf | Record |
| | | | duration |
| } | | | |

### Time Slot Record Right Descriptor

| | Bit | | |
|---|---|---|---|
| Field | number | Type | Description |
| RecordTimeSlot_Descriptor{ | | | |
| Tag | 16 | Uimsbf | 0x8103 |
| Length | 16 | Uimsbf | |
| RecordStartTime | 64 | Uimsbf | Record start |
| | | | time, UTC |
| | | | time |
| RecordEndTIme | 64 | Uimsbf | Record end |
| | | | time, UTC |
| | | | time |
| } | | | |

### Region Record Right Descriptor

| | Bit | | |
|---|---|---|---|
| Field | number | Type | Description |
| RecordRegion_Descriptor{ | | | |
| Tag | 16 | Uimsbf | 0x8104 |
| Length | 16 | Uimsbf | |
| Record_Region_ID | 32 | Uimsbf | Record region |
| | | | ID |
| } | | | |

### Quality Record Right Descriptor

| | Bit | | |
|---|---|---|---|
| Field | number | Type | Description |
| PlayQuality_Descriptor{ | | | |
| Tag | 16 | Uimsbf | 0x8105 |
| Length | 16 | Uimsbf | |
| Record_Quality | 8 | Uimsbf | Record quality |
| | | | (0: all; |
| | | | 1: standard |
| | | | definition; |
| | | | 2: high |
| | | | definition; |
| | | | 3: ultrahigh |
| | | | definition) |
| } | | | |

### Count Copy Right Descriptor

| | Bit | | |
|---|---|---|---|
| Field | number | Type | Description |
| CopyCount_Descriptor{ | | | |
| Tag | 16 | Uimsbf | 0x8201 |
| Length | 16 | Uimsbf | |
| CopyCount | 32 | Uimsbf | Copy count |
| } | | | |

### Duration Copy Right Descriptor

| | Bit | | |
|---|---|---|---|
| Field | number | Type | Description |
| CopyDuration_Descriptor{ | | | |
| Tag | 16 | Uimsbf | 0x8202 |
| Length | 16 | Uimsbf | |
| CopyDuration | 32 | Uimsbf | Copy Duration |
| } | | | |

### Time Slot Copy Right Descriptor

| | Bit | | |
|---|---|---|---|
| Field | number | Type | Description |
| CopyTimeSlot_Descriptor{ | | | |
| Tag | 16 | Uimsbf | 0x8203 |
| Length | 16 | Uimsbf | |
| CopyStartTime | 64 | Uimsbf | Copy start |
| | | | time, UTC |
| | | | time |
| CopyEndTIme | 64 | Uimsbf | Copy end |
| | | | time, UTC |
| | | | time |
| } | | | |

### Region Copy Right Descriptor

| | Bit | | |
|---|---|---|---|
| Field | number | Type | Description |
| CopyRegion_Descriptor{ | | | |
| Tag | 16 | Uimsbf | 0x8204 |
| Length | 16 | Uimsbf | |
| Copy_Region_ID | 32 | Uimsbf | Copy region |
| | | | ID |
| } | | | |

### Quality Copy Right Descriptor

| | Bit | | |
|---|---|---|---|
| Field | number | Type | Description |
| CopyQuality_Descriptor{ | | | |
| Tag | 16 | Uimsbf | 0x8205 |
| Length | 16 | Uimsbf | |
| Copy_Quality | 8 | Uimsbf | Copy quality |
| | | | (0: all |
| | | | 1: standard |
| | | | definition; |
| | | | 2: high |
| | | | definition; |
| | | | 3: ultrahigh |
| | | | definition) |
| } | | | |

### Copy Transmitting Right Descriptor

| | Bit | | |
|---|---|---|---|
| Field | number | Type | Description |
| CopyGeneration_Descriptor{ | | | |
| Tag | 16 | Uimsbf | 0x8206 |
| Length | 16 | Uimsbf | |
| Copy_Generation | 8 | Uimsbf | Copy |
| | | | transmitting, |
| | | | limited to how |
| | | | many copy |
| | | | generations |
| } | | | |

### Count Storage Right Descriptor

| | Bit | | |
|---|---|---|---|
| Field | number | Type | Description |
| StoreCount_Descriptor{ | | | |
| Tag | 16 | Uimsbf | 0x8301 |
| Length | 16 | Uimsbf | |
| StoreCount | 32 | Uimsbf | Store count |
| } | | | |

### Duration Storage Right Descriptor

| | Bit | | |
|---|---|---|---|
| Field | number | Type | Description |
| StoreDuration_Descriptor{ | | | |
| Tag | 16 | Uimsbf | 0x8302 |
| Length | 16 | Uimsbf | |
| StoreDuration | 32 | Uimsbf | Store duration |
| } | | | |

### Time Slot Storage Right Descriptor

| | Bit | | |
|---|---|---|---|
| Field | number | Type | Description |
| StoreTimeSlot_Descriptor{ | | | |
| Tag | 16 | Uimsbf | 0x8303 |
| Length | 16 | Uimsbf | |
| StoreStartTime | 64 | Uimsbf | Store start |
| | | | time, UTC |
| | | | time |
| StoreEndTIme | 64 | Uimsbf | Store end |
| | | | time, UTC |
| | | | time |
| } | | | |

### Region Storage Right Descriptor

| | Bit | | |
|---|---|---|---|
| Field | number | Type | Description |
| StoreRegion_Descriptor{ | | | |
| Tag | 16 | Uimsbf | 0x8304 |
| Length | 16 | Uimsbf | |
| Store_Region_ID | 32 | Uimsbf | Store region |
| | | | ID |
| } | | | |

### Quality Storage Right Descriptor

| | Bit | | |
|---|---|---|---|
| Field | number | Type | Description |
| StoreQuality_Descriptor{ | | | |
| Tag | 16 | Uimsbf | 0x8305 |
| Length | 16 | Uimsbf | |
| Store_Quality | 8 | Uimsbf | Store quality |
| | | | (0: all; |
| | | | 1: standard |
| | | | definition; |
| | | | 2: high |
| | | | definition; |
| | | | 3: ultrahigh |
| | | | definition) |
| } | | | |

### Count Forwarding Right Descriptor

| | Bit | | |
|---|---|---|---|
| Field | number | Type | Description |
| TransferCount_Descriptor{ | | | |
| Tag | 16 | Uimsbf | 0x8401 |
| Length | 16 | Uimsbf | |
| TransferCount | 32 | Uimsbf | Forwarding |
| | | | count |
| } | | | |

### Duration Forwarding Right Descriptor

| | Bit | | |
|---|---|---|---|
| Field | number | Type | Description |
| TransferDuration_Descriptor{ | | | |
| Tag | 16 | Uimsbf | 0x8402 |
| Length | 16 | Uimsbf | |
| TransferDuration | 32 | Uimsbf | Forwarding |
| | | | duration |
| } | | | |

### Time Slot Forwarding Right Descriptor

| | Bit | | |
|---|---|---|---|
| Field | number | Type | Description |
| TransferTimeSlot_Descriptor{ | | | |
| Tag | 16 | Uimsbf | 0x8403 |
| Length | 16 | Uimsbf | |
| TransferStartTime | 64 | Uimsbf | Forwarding |
| | | | start time, |
| | | | UTC time |
| TransferEndTIme | 64 | Uimsbf | Forwarding |
| | | | end time, |
| | | | UTC time |
| } | | | |

### Region Forwarding Right Descriptor

| | Bit | | |
|---|---|---|---|
| Field | number | Type | Description |
| TransferRegion_Descriptor{ | | | |
| Tag | 16 | Uimsbf | 0x8404 |
| Length | 16 | Uimsbf | |
| Transfer_Region_ID | 32 | Uimsbf | Forwarding |
| | | | region ID |
| } | | | |

### Quality Forwarding Right Descriptor

| | Bit | | |
|---|---|---|---|
| Field | number | Type | Description |
| TransferQuality_Descriptor{ | | | |
| Tag | 16 | Uimsbf | 0x8405 |
| Length | 16 | Uimsbf | |
| Transfer_Quality | 8 | Uimsbf | Forwarding |
| | | | quality (0: all; |
| | | | 1: standard |
| | | | definition; |
| | | | 2: high |
| | | | definition; |
| | | | 3: ultrahigh |
| | | | definition) |
| } | | | |

### Count Execution Right Descriptor

| | Bit | | |
|---|---|---|---|
| Field | number | Type | Description |
| ExecuteCount_Descriptor{ | | | |
| Tag | 16 | Uimsbf | 0x8501 |
| Length | 16 | Uimsbf | |
| ExecuteCount | 32 | Uimsbf | Execute count |
| } | | | |

### Duration Execution Right Descriptor

| | Bit | | |
|---|---|---|---|
| Field | number | Type | Description |
| ExecuteDuration_Descriptor{ | | | |
| Tag | 16 | Uimsbf | 0x8502 |
| Length | 16 | Uimsbf | |
| ExecuteDuration | 32 | Uimsbf | Execute |
| | | | duration |
| } | | | |

### Time Slot Execution Right Descriptor

| | Bit | | |
|---|---|---|---|
| Field | number | Type | Description |
| ExecuteTimeSlot_Descriptor{ | | | |
| Tag | 16 | Uimsbf | 0x8503 |
| Length | 16 | Uimsbf | |
| ExecuteStartTime | 64 | Uimsbf | Execute start |
| | | | time, UTC |
| | | | time |
| ExecuteEndTIme | 64 | Uimsbf | Execute end |
| | | | time, UTC |
| | | | time |
| } | | | |

### Region Execution Right Descriptor

| | Bit | | |
|---|---|---|---|
| Field | number | Type | Description |
| ExecuteRegion_Descriptor{ | | | |
| Tag | 16 | Uimsbf | 0x8504 |
| Length | 16 | Uimsbf | |
| Execute_Region_ID | 32 | Uimsbf | Execute |
| | | | region ID |
| } | | | |

To obtain the right of a certain object for a certain content, the right formula needs to be established according to the logical operator in the content right descriptor to calculate the content rights.

Examples are as follows:

a user 1 is allowed to play a program 1 according to count and can play for 10 times.

A right packaging method provided by the present invention is adopted as follows:

A. the content is the program 1 (Program 1);

B. the object is the user 1 (User 1);

C. the right is a count right 1 (Right 1);

D. right operation: right formula=(Program 1) and (User 1) and (Right 1).

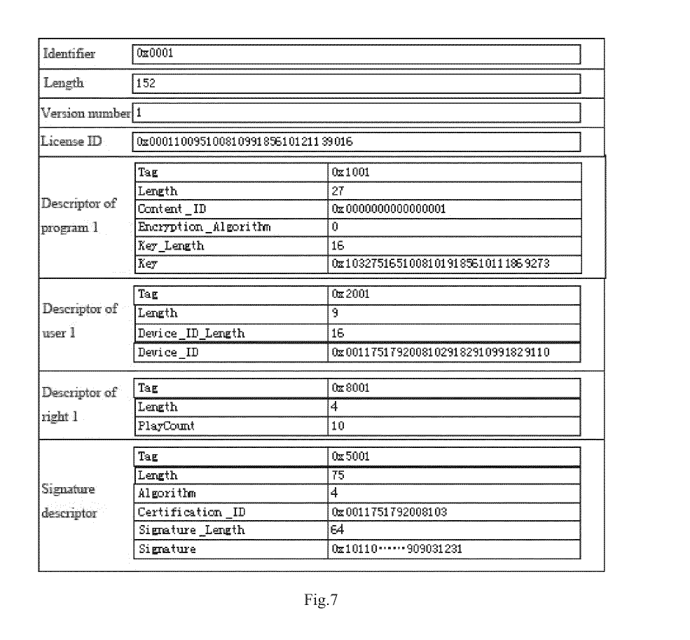

FIG. 7 is a content right description completed according to the right formula by using the right operation method. The Tag value of the right description is 0x0001.

1. A content descriptor is defined.

The Tag of the descriptor of the program 1 is 0x0001, and RightsIndex in the right description is 0.

2. An object descriptor is defined.

The Tag of the descriptor of the user 1 is 0x2001, and RightsIndex in the right description is 1.

3. A right descriptor is defined.

The Tag of the descriptor of the right 1 is 0x8001, and RightsIndex in the right description is 2.

The content right description is completed, since there is no calculator descriptor in the description, all of the above-mentioned descriptors form AND relationship, and the content rights can be calculated by means of the right formula=(the descriptor of the program 1) and (the descriptor of the user 1) and (the descriptor of the right 1).

It can be seen from the above-mentioned content right packaging that, the right description can be used for defining the right ranges of play, storage, copy, forwarding, execution and the like, such that the data size of the right information is smaller, the efficiency is higher and the application is wider.

To sum up, the content rights are defined to describe and bind the relationship of the content, the object and the right, the right formula is generated through a right logical operation method, and the content, the object, the right and the logical operation are packaged by the tag to flexibly define the content rights concisely, ensure the compatibility of versions with different content right descriptions and guarantee strong expansibility; meanwhile, the rights are described by the binary system to effectively save the storage space, which is particularly effective to embedded equipment; in addition, by adopting the tag descriptor, the existing descriptor analyzer can be adopted, thus the development efficiency can be greatly improved, meanwhile, the expression and implementation are very simple and the interoperability is strong.

The purposes, technical solutions and beneficial effects of the prevent invention have been further described in detail in the foregoing specific embodiments, it should be understood that, the foregoing descriptions are merely preferred embodiments of the present invention, rather than limiting the protection scope of the present invention. Any modifications, equivalent substitutions and improvements or the like made within the spirit and principle of the present invention shall fall within the protection scope of the present invention.

We claim:

1. A method for packaging content rights, comprising:
describing and binding the relationship of a content, an object and a right by using a data structure with a tag;
obtaining a corresponding right logical operator;
calculating the content, the object and the right according to the obtained right logical operator by using a calculator to generate a right formula;
describing the content rights according to the operational result of the right formula.

2. The method of claim 1, wherein the content is an electronic thing, and the content can be a graph, a text, audio, video, animation and a set thereof, and can also be a file, a database, software and an executable code.

3. The method of claim 1, wherein the object is a carrier of related rights of appointed contents, and the object can be people, equipment, region, time and family.

4. The method of claim 1, wherein the right is the authority of using the content, and the right can be count, duration, time, range and manner.

5. The method of claim 3, wherein the equipment can be a general term of software, hardware and a set thereof, which are distinguished from other things, and the equipment can be a computer, a computer cluster, a home network, a domain, a cell network, a server, a television, a mobile phone, a tablet computer, a display, a CPU, a memory, a hard disk, FLASH, RAM, an operating system, a browser, player software, and can be software, hardware and a set thereof.

6. The method of claim 4, wherein a plurality of rights need to be used at the same time.

7. The method of claim 1, wherein the content, the object and the right are described by the data structure with the tag.

8. The method of claim 1, wherein the right logical operator comprises AND, OR, NOT, XOR operations.

9. The method of claim 8, wherein the right logical operator describes the index numbers of descriptors participating in the operation, the index numbers are sequentially numbered according to the position sequences of the descriptors in a content right descriptor and are numbered from 0, and the logical operator is numbered as well and can also be quoted by the subsequent logical operator so as to achieve iterative operation.

10. The method of claim 9, wherein the right formula comprises all applicable operations.

11. The method of claim 1, wherein the right formula is described by the data structure with the tag.

12. The method of claim 1, wherein the content right description can be compressed.

13. The method of claim 1, wherein as for the right logical operators for describing a right operation method, there may be none, and if there is none, the content, the object and the right all form AND relationship.

14. The method of claim 1, wherein the content right description is composed of an tag, a length, a version, a serial number, a content descriptor, an object descriptor, a right descriptor, a calculator descriptor and a signature descriptor.

15. The method of claim 1, wherein the right descriptor is used for describing the right description needing to participate in the operation, and there must be at least one and may be multiple.

16. The method of claim 15, wherein the right descriptor is composed of a count descriptor, a duration descriptor, a time slot descriptor, a content quality descriptor, a parental control rule descriptor, a display rule descriptor, a display screen resolution rule descriptor, a region descriptor, a content play right descriptor, a content recording rule descriptor, a content forwarding rule descriptor, a content copy descriptor, a content modification rule descriptor, a right storage rule descriptor and a right forwarding rule descriptor.
